(19) United States
(12) Patent Application Publication
(10) Pub. No.: US 2021/0289083 A1
(43) Pub. Date: Sep. 16, 2021

(54) IMAGE FORMING SYSTEM AND IMAGE FORMING METHOD

(71) Applicant: TOSHIBA TEC KABUSHIKI KAISHA, Tokyo (JP)

(72) Inventor: Setsuo TAKADA, Izunokuni Shizuoka (JP)

(73) Assignee: TOSHIBA TEC KABUSHIKI KAISHA, Tokyo (JP)

(21) Appl. No.: 16/814,769

(22) Filed: Mar. 10, 2020

(51) Int. Cl. H04N 1/00; G06K 17/00; G06K 19/07; G06K 19/077

(52) U.S. Cl. CPC H04N 1/00339; G06K 17/0025; H04N 1/00342; G06K 19/07749; G06K 19/0723

(57) ABSTRACT

An image forming system includes an image forming apparatus and a writing device. The image forming apparatus includes an input and output unit and an image forming unit. The input and output unit acquires image information and write information to be written to a wireless tag. The input and output unit outputs the write information to the writing device. The image forming unit forms an image on a sheet to which the wireless tag is attached, based on the image information. The writing device includes an acquisition unit and a writing unit. The acquisition unit acquires the write information. The writing unit writes the acquired write information to the wireless tag via an antenna.

### FIELD

Embodiments described herein relate generally to an image forming system and an image forming method.

### BACKGROUND

With respect to a sheet to which a wireless tag is attached, there is an image forming apparatus that forms (prints) an image on the sheet and writes information to the wireless tag. The wireless tag refers to, for example, a radio frequency identifier (RFID) tag. The writing and reading information to and from the wireless tag is performed by a read and write device. Generally, the read and write device includes an antenna, a controller that controls the antenna, a shield member, and the like. The shield member stabilizes the writing and reading of the information. In the related art, the read and write device is arranged inside the image forming apparatus while avoiding image forming components. Accordingly, in the related art, there has been a problem in that an internal structure of the image forming apparatus becomes complicated. For example, if the image forming apparatus is replaced with a new model having a different internal structure, a re-design of the arrangement of the read and write device is required.

### DESCRIPTION OF THE DRAWINGS

FIG. 1 is an external view illustrating an image forming apparatus according to an exemplary embodiment;

FIG. 2 is a diagram illustrating a system configuration of an image forming system according to the exemplary embodiment;

FIG. 3 is a block diagram illustrating a hardware configuration of the image forming apparatus according to the exemplary embodiment;

FIG. 4 is a block diagram illustrating a hardware configuration of a write information server of the exemplary embodiment;

FIG. 5 is a block diagram illustrating a hardware configuration of a read and write device of the exemplary embodiment;

FIG. 6 is a diagram illustrating internal configurations of the image forming apparatus and the read and write device of the exemplary embodiment;

FIG. 7 is a flowchart illustrating an operation of the image forming apparatus according to the exemplary embodiment;

FIG. 8 is a flowchart illustrating an operation of the read and write device of the exemplary embodiment;

FIG. 9 is a schematic diagram illustrating a relationship between a radiation direction of general electromagnetic waves and a direction of a wireless tag;

FIG. 10 is a schematic diagram illustrating a relationship between a radiation direction of electromagnetic waves and the direction of the wireless tag according to the exemplary embodiment;

FIG. 11 is a diagram illustrating a first position for providing the read and write device to the image forming apparatus according to the exemplary embodiment; and

FIG. 12 is a diagram illustrating a second position for providing the read and write device to the image forming apparatus according to the exemplary embodiment.

### DETAILED DESCRIPTION

Embodiments of the present invention can be configured, but are not required, to provide an image forming system and an image forming method that can easily write and read information to and from a wireless tag regardless of the internal structure of the image forming apparatus.

According to the exemplary embodiments disclosed herein, an image forming system has an image forming apparatus and a writing device. The image forming apparatus includes an input and output unit and an image forming unit. The input and output unit is, for example, an I/O device that acquires image information and write information written to a wireless tag. The I/O device outputs the write information to the writing device. The image forming unit forms an image based on the image information on a sheet to which the wireless tag is attached. The writing device includes an acquisition unit and a writing unit. The acquisition unit acquires the write information. The writing unit writes the acquired write information to the wireless tag via an antenna.

Hereinafter, the image forming apparatus and the image forming method according to an exemplary embodiment are described with reference to drawings.

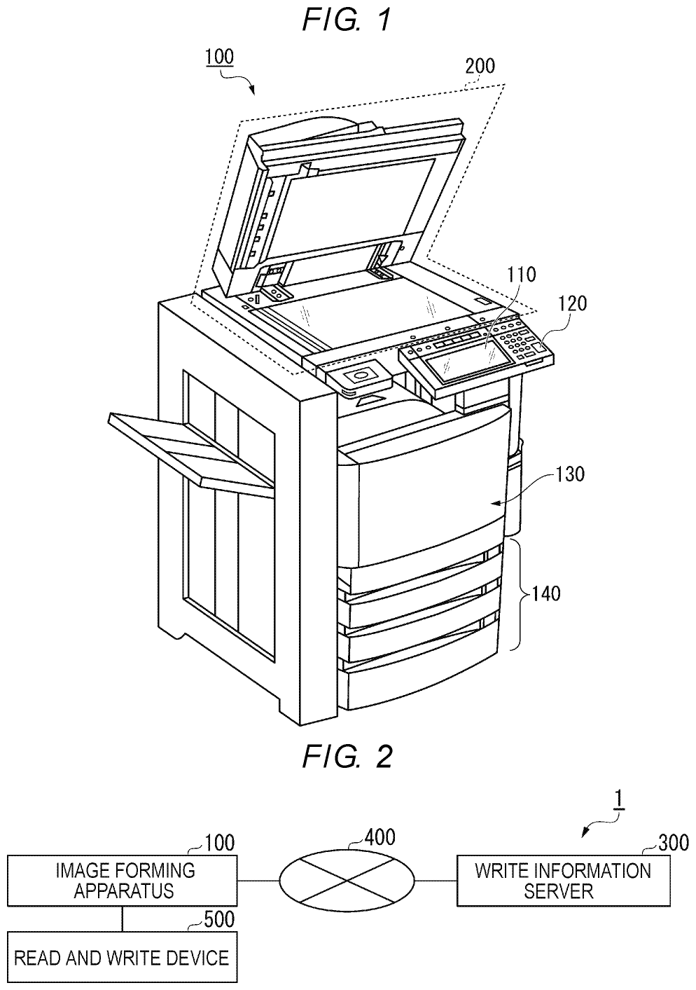

Hereinafter, an example of the entire configuration of an image forming apparatus 100 is described. FIG. 1 is an external view illustrating the entire configuration of the image forming apparatus 100 according to the exemplary embodiment. The image forming apparatus 100 is, for example, a multifunction peripheral (MFP). The image forming apparatus 100 includes a display 110, a control panel 120, a printer unit 130, a sheet storage unit 140, and an image reading unit 200. The printer unit 130 of the image forming apparatus 100 may be an electrophotographic device for fixing a toner image, or may be an inkjet device.

The image forming apparatus 100 forms an image on a sheet by using a developer such as a toner. The sheet is, for example, paper or label paper. The sheet may be any printing medium such that the image forming apparatus 100 can form an image on the surface thereof. The sheet may be a sheet to which a wireless tag is attached. The wireless tag is, for example, an RFID tag. The sheet to which the wireless tag is attached may be a sheet with the wireless tag attached to the surface of the sheet or may be a sheet with the wireless tag embedded inside the sheet.

The display 110 is an image display device such as a liquid crystal display and an organic electro luminescence (EL) display. The display 110 displays various kinds of information related to the image forming apparatus 100.

The control panel 120 has a plurality of buttons. The control panel 120 receives an operation from a user. The control panel 120 outputs a signal corresponding to an operation performed by the user to a processor of the image forming apparatus 100. The display 110 and the control panel 120 may be configured as an integrated touch panel.

The printer unit 130 forms an image on a sheet based on image information generated by the image reading unit 200 or image information acquired via a communication path. The printer unit 130 forms an image, for example, by the following processing. The printer unit 130 forms an electrostatic latent image on a photosensitive drum based on the image information. The printer unit 130 forms a visible image by attaching a developer to the electrostatic latent image. As a specific example of the developer, there is a toner. The printer unit 130 transfers a visible image onto a sheet. The printer unit 130 fixes a visible image on the sheet by applying heat and pressure to the sheet. The sheet on which an image is formed may be a sheet stored in the sheet storage unit 140 or may be a manually fed sheet.

The sheet storage unit 140 stores a sheet used for forming an image in the printer unit 130.

The image reading unit 200 reads image information of a target to be read based on brightness and darkness. The image reading unit 200 records the read image information. The recorded image information may be output to another information processing device via the network. The recorded image information may form an image on the sheet by the printer unit 130.

Hereinafter, an example of a system configuration of the image forming system 1 is described. FIG. 2 is a system configuration diagram illustrating a system configuration of the image forming system 1 according to the exemplary embodiment.

An image forming system 1 is provided on a network 400. The image forming system 1 includes the image forming apparatus 100, a write information server 300, and a read and write device 500. The image forming apparatus 100 and the write information server 300 are communicably connected to each other via the network 400. For example, the network 400 is a wide area communication network such as the Internet. The network 400 may be a network using wireless communication or a network using wired communication. The network 400 may be configured by combining a plurality of networks.

For example, the write information server 300 is configured by an information processing device such as a server or a personal computer. The write information server 300 outputs write information to be written to a wireless tag attached to a sheet in response to a request from the image forming apparatus 100. The write information is information to be written to the wireless tag attached to the sheet. The write information is, for example, information such as a Japan Article Numbering (JAN) code and a serial number. For example, the write information is written in an electronic product code (EPC) area of the RFID tag.

The read and write device 500 is provided outside the image forming apparatus 100. The read and write device 500 is provided near a conveyance path of the sheet in the image forming apparatus 100. The read and write device 500 can write the write information to the wireless tag attached to a sheet conveyed inside of the image forming apparatus 100.

The image forming apparatus 100 and the read and write device 500 are communicably connected to each other via a communication line. The image forming apparatus 100 and the read and write device 500 may be connected to each other by wireless communication.

The read and write device 500 acquires write information output from the write information server 300 via the communication network 400, the image forming apparatus 100, and a communication line. The read and write device 500 writes the acquired write information to the wireless tag which is attached to the sheet conveyed inside of the image forming apparatus 100.

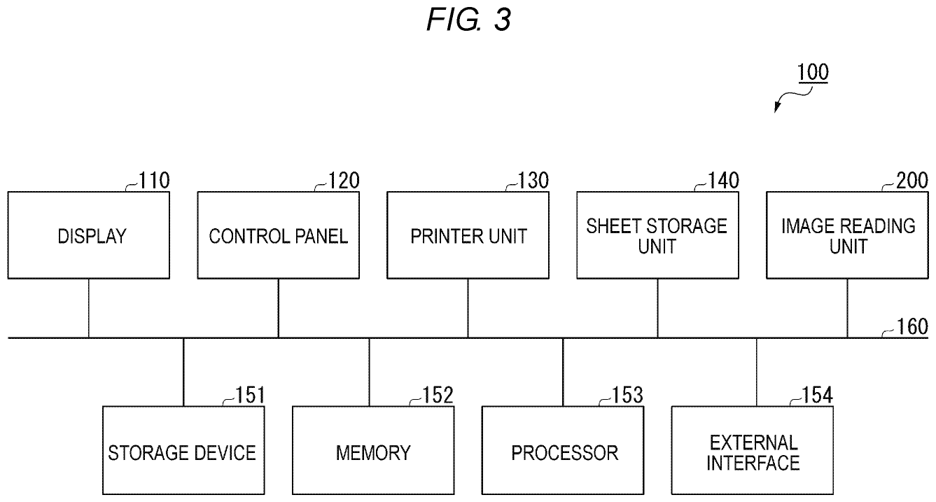

Hereinafter, an example of a hardware configuration of the image forming apparatus 100 will be described. FIG. 3 is a block diagram illustrating a hardware configuration of the image forming apparatus 100 according to the exemplary embodiment.

The image forming apparatus 100 includes the display 110, the control panel 120, the printer unit 130, the sheet storage unit 140, a storage device 151, a memory 152, a processor 153, an external interface 154, and the image reading unit 200. The display 110, the control panel 120, the printer unit 130, the sheet storage unit 140, and the image reading unit 200 are not described here, because the descriptions thereof are provided above. Hereinafter, the storage device 151, the memory 152, the processor 153, and the external interface 154 are described. Each functional unit is connected via a system bus 160 capable of data communication.

The storage device 151 is, for example, a hard disk or a solid state drive (SSD), and stores various data. The various data are a software program for controlling a print job received from an external communication device and an operation of each functional unit of the image forming apparatus 100 for example. The print job may include image information relating to an image to be printed on the sheet. The print job may be a job relating to double-sided printing or may be a job relating to printing a plurality of sheets. The print job may include information indicating which write information is acquired from the write information server 300.

The memory 152 temporarily stores data used by each functional unit included in the image forming apparatus 100. The memory 152 is, for example, a random access memory (RAM). The memory 152 may store digital data generated by the image reading unit 200. The memory 152 may temporarily store a print job for image formation (printing) performed by the printer unit 130 and write information acquired from the write information server 300 and written to the wireless tag.

The processor 153 controls the operation of each functional unit of the image forming apparatus 100. The processor 153 loads a software program stored in the storage device 151 onto the memory 152, and executes the software program to execute processing.

Here, specific processing of the processor 153 is described with reference to an example. The processor 153 controls image formation (printing) on a sheet to which a wireless tag is attached, based on a print job received via an external information processing device (for example, a personal computer) or the control panel 120. When a print job relating to a sheet to which a wireless tag is attached is received, the processor 153 acquires the image information designated in the print job and the write information associated with the image information from the write information server 300. The image information is information corresponding to an image formed on the sheet. It is not required that the image information and the write information are necessarily associated with each other. In this case, for example, the print job only needs to include at least image information.

The processor 153 controls the sheet storage unit 140. The sheet storage unit 140 feeds a sheet to which a wireless tag is attached to the printer unit 130. The processor 153 controls the printer unit 130. The printer unit 130 forms (prints) an image on a sheet by using the image information acquired from the write information server 300.

The external interface 154 transmits and receives data to and from an external device. Here, the external device is, for example, an information processing device such as a personal computer, a tablet terminal, a smart device, or an information processing device such as the write information server 300. The external interface 154 operates as an input interface and acquires data or various instructions output from an external device. The instruction output from the external device is, for example, a print job or the like. The data output from the external device is, for example, image information and write information associated with the corresponding image information. The external interface 154 operates as an output interface and outputs data to an external device.

The external device is, for example, the read and write device 500. The external interface 154 outputs the write information acquired from the write information server 300 to the read and write device 500 via a communication line under the control of the processor 153.

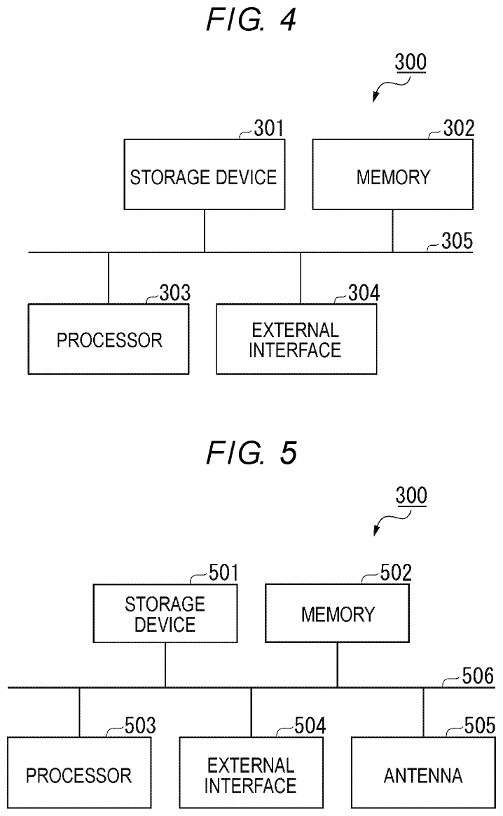

Hereinafter, the hardware configuration of the write information server 300 is described. FIG. 4 is a block diagram illustrating a hardware configuration of the write information server 300 of the exemplary embodiment.

The write information server 300 includes a storage device 301, a memory 302, a processor 303, and an external interface 304. Each functional unit is connected via a system bus 305 capable of data communication.

The storage device 301 is, for example, a hard disk or SSD, and stores various data. The various data are image information and write information written to the wireless tag. The various data are a software program for controlling the operation of each functional unit of the write information server 300.

The memory 302 temporarily stores data used by each functional unit included in the writing information server 300. The memory 302 is, for example, a RAM.

The processor 303 controls the operation of each functional unit of the writing information server 300. The processor 303 executes processing by loading the software program stored in the storage device 301 onto the memory 302 and executing the software program.

Here, the specific processing of the processor 303 is described with reference to an example. The processor 303 receives a request for acquiring image information and write information associated with the corresponding image information from the image forming apparatus 100 via the external interface 304. The processor 303 outputs the requested image information and the write information associated with the corresponding image information to the image forming apparatus 100.

The external interface 304 transmits and receives data to and from an external device. Here, the external device is, for example, the image forming apparatus 100. The external interface 304 operates as an input interface and acquires data or instructions output from an external device. The instruction output from the external device is a request to acquire the image information and the write information. The external interface 304 operates as an output interface, and outputs data to an external device.

Hereinafter, an example of the hardware configuration of the read and write device 500 is described. FIG. 5 is a block diagram illustrating a hardware configuration of the read and write device 500 of the exemplary embodiment.

The read and write device 500 includes a storage device 501, a memory 502, a processor 503, an external interface 504, and an antenna 505. Each functional unit is connected via a system bus 506 capable of data communication.

The storage device 501 is, for example, a hard disk or SSD and stores various data. The various data are a software program for controlling the operation of each functional unit of the read and write device 500 for example.

The memory 502 temporarily stores data used by each functional unit included in the read and write device 500. The memory 502 is, for example, a RAM.

The processor 503 controls the operation of each functional unit of the read and write device 500. The processor 503 loads a software program stored in the storage device 501 onto the memory 502, and executes processing by executing the software program.

Here, the specific processing of the processor 503 is described with reference to an example. The processor 503 acquires write information from the image forming apparatus 100 via the external interface 504. The processor 503 outputs the acquired write information via the antenna 505.

The external interface 504 transmits and receives data to and from an external device. Here, the external device is, for example, the image forming apparatus 100. The external interface 504 operates as an input interface and acquires data output from the external device. The data output from the external device is, for example, write information. The external interface 504 may operate as an output interface and output data to the external device.

The antenna 505 writes information to the wireless tag attached to the sheet. The antenna 505 reads information from the wireless tag attached to the sheet. The antenna 505 operates as a writing device of the wireless tag to write the write information acquired from the write information server 300 to the wireless tag attached to the sheet conveyed inside of the image forming apparatus 100.

The antenna 505 is a component of a wireless tag reading unit and a wireless tag recording unit. The antenna 505 is configured to perform both writing of information and reading of information with respect to the wireless tag, but the invention is not limited thereto. For example, in the antenna 505, a writing antenna and a reading antenna may be provided as different antennas.

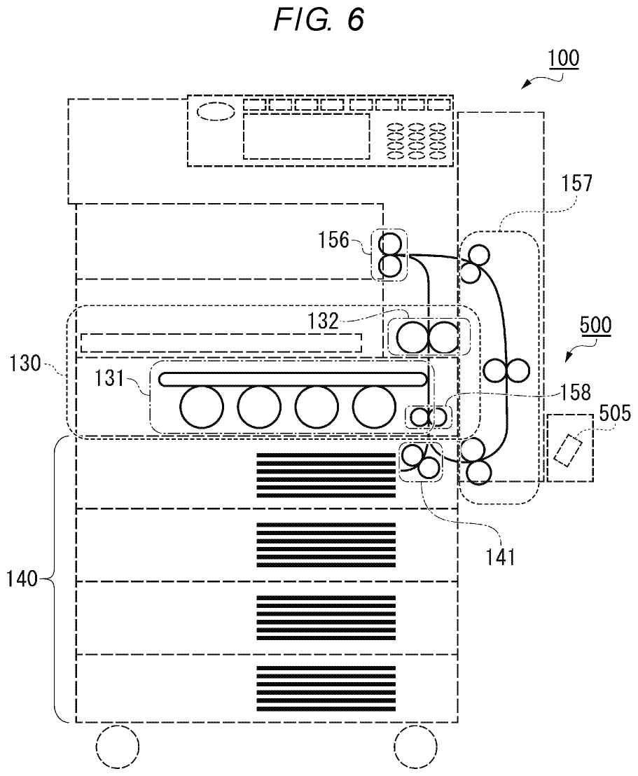

Hereinafter, specific examples of internal configurations of the image forming apparatus 100 and the read and write device 500 are described. FIG. 6 is a diagram illustrating internal configurations of the image forming apparatus 100 and the read and write device 500 of the exemplary embodiment.

The image forming apparatus 100 includes the printer unit 130, the sheet storage unit 140, a sheet discharging unit 156, a sheet reversing path 157, and a registration unit 158. The printer unit 130 includes an image forming unit 131 and a fixing unit 132. The sheet storage unit 140 includes a sheet feeding unit 141. The printer unit 130 and the sheet storage unit 140 are not described, because the descriptions thereof are provided above. Hereinafter, the image forming unit 131, the fixing unit 132, the sheet feeding unit 141, the sheet discharging unit 156, the sheet reversing path 157, and the registration unit 158 are described.

The image forming unit 131 includes a predetermined toner. According to the present exemplary embodiment, yellow, cyan, magenta, and black toners are provided from the upstream side (left side in the figure). The predetermined toner may be a special toner such as a decoloring toner. The image forming unit 131 includes a developing unit (developer), a photosensitive drum, and a charging unit (not illustrated) for each toner. The charging unit uniformly charges the surface (photoconductor layer) of the photosensitive drum. The photosensitive drum forms an electrostatic latent image on the surface when irradiated with laser light. The developer performs development by adding toners to the electrostatic latent image. The image forming unit 131 includes a transfer belt. Images developed with the respective toners are sequentially transferred onto the transfer belt in a superimposed manner. The superimposed and transferred images are then transferred to a sheet by a transfer roller (not illustrated). According to the present exemplary embodiment, the image forming method using an intermediate transfer method is described as described above, but for example, a direct transfer method or another transfer method may be used.

The fixing unit 132 includes a heating roller and a pressure roller. The heating roller applies heat to the sheet from one surface side of the sheet. The pressure roller applies pressure to the sheet from the other surface side of the sheet. The fixing unit 132 fixes the toners transferred to the sheet by applying heat and pressure to the sheet.

The sheet feeding unit 141 feeds a sheet stored in the sheet storage unit 140. The sheet feeding unit 141 is configured by, for example, sheet feeding rollers. The sheet discharging unit 156 discharges the sheet conveyed inside of the image forming apparatus 100. The sheet discharging unit 156 is configured by, for example, sheet discharging rollers.

The sheet reversing path 157 is a path for reversing the sheet in order to form an image on the other surface of the sheet surface on which the image is formed. The sheet reversing path 157 is a path for reversing and conveying the sheet conveyed to the sheet discharge unit 156 by switchback.

The registration unit 158 is registration rollers provided downstream (upper side in the drawing) of the sheet storage unit 140 in the conveyance path of the sheet. The registration unit 158 temporarily reduces the conveyance speed of the sheet or temporarily stops the sheet conveyance. The registration unit 158 corrects the inclination of the sheet to be perpendicular to the conveyance direction by temporarily reducing the conveyance speed of the sheet or stopping the sheet conveyance.

The read and write device 500 is provided outside the image forming apparatus 100 as illustrated in FIG. 6. The read and write device 500 is provided, for example, near a position of the downstream (upper side in the drawing) with respect to the registration unit 158 in the conveyance path of the sheet. The read and write device 500 includes the antenna 505.

The antenna 505 constantly waits for detection of a signal transmitted from the wireless tag, for example, by a UHF band electromagnetic wave. When the sheet to which the wireless tag is attached passes through the registration unit 158 and approaches the antenna 505, the antenna 505 detects a signal transmitted from the wireless tag. Accordingly, the communication between the antenna 505 and the wireless tag is established, and writing information is written to the wireless tag.

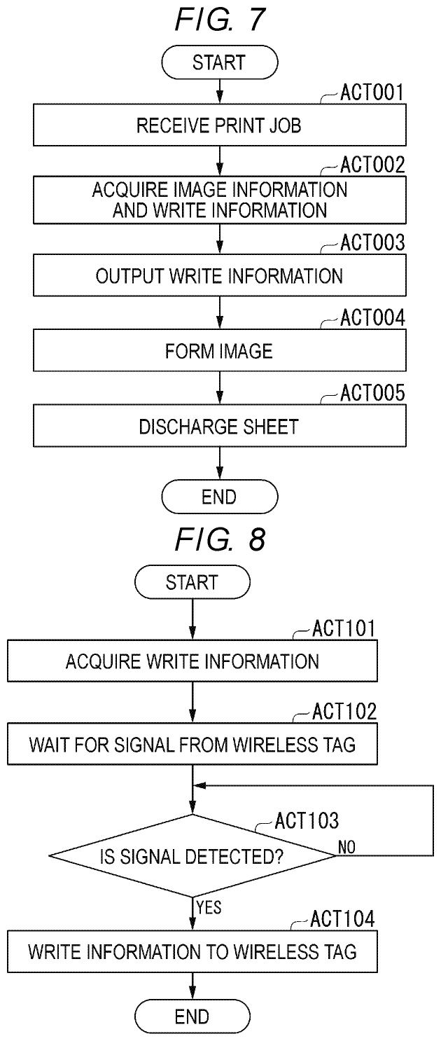

Hereinafter, an example of the operation of the image forming apparatus 100 is described. FIG. 7 is a flowchart illustrating the operation of the image forming apparatus 100 according to the exemplary embodiment. The operation illustrated in this flowchart is executed when the image forming apparatus 100 receives a print job for forming (printing) an image on a sheet to which a wireless tag is attached.

The processor 153 of the image forming apparatus 100 receives a print job (ACT001). Specifically, for example, an external information processing device such as a personal computer outputs the print job to the image forming apparatus 100 via the network 400. The processor 153 of the image forming apparatus 100 acquires the print job via the external interface 154.

The processor 153 acquires image information and write information associated with the corresponding image information (ACT002). Specifically, when receiving the print job, the processor 153 requests to acquire the image information and the write information associated with the corresponding image information from the write information server 300 via the external interface 154. The write information server 300 outputs the requested image information and the requested write information associated with the corresponding image information to the image forming apparatus 100.

The processor 153 outputs the write information to the read and write device 500 via the external interface 154 (ACT003).

The printer unit 130 forms (prints) an image on the conveyed sheet (ACT004). Specifically, when the processor 153 receives the print job, the sheet to which the wireless tag is attached is fed from the sheet storage unit 140. The printer unit 130 develops the image based on the acquired image information. The printer unit 130 fixes the developed image to the fed sheet to form the image.

When the image formation is completed, the image forming apparatus 100 discharges the sheet (ACT005). The operation of the image forming apparatus 100 illustrated in the flowchart of FIG. 7 is completed.

Hereinafter, an example of the operation of the read and write device 500 is described. FIG. 8 is a flowchart illustrating the operation of the read and write device 500 of the exemplary embodiment. The operation illustrated in this flowchart is executed when the read and write device 500 acquires the write information. The write information acquired here is the write information output from the image forming apparatus 100 in ACT003 of the flowchart illustrated in FIG. 7.

The processor 503 of the read and write device 500 acquires write information (ACT101). Specifically, the image forming apparatus 100 outputs the write information to the read and write device 500 via a communication line. The read and write device 500 acquires the write information via the external interface 504.

The processor 503 waits for a signal transmitted from the wireless tag (ACT102). If the processor 503 detects the signal transmitted from the wireless tag (ACT103: Yes), the antenna 505 writes the write information acquired from the image forming apparatus 100 to the wireless tag via the antenna 505 (ACT104).

Specifically, if the processor 503 acquires the write information, the antenna 505 emits an electromagnetic wave. When the wireless tag attached to the sheet conveyed inside of the image forming apparatus 100 enters an irradiation range of the electromagnetic wave, an electromotive force is generated in the wireless tag due to a resonance action or the like. A signal is transmitted from the antenna of the wireless tag by the electromotive force. The antenna 505 of the read and write device 500 detects the signal transmitted from the wireless tag. When detecting the signal with the antenna 505, the processor 503 radiates an electromagnetic wave for writing the write information to the wireless tag via the antenna 505. The wireless tag detects the electromagnetic wave radiated from the antenna 505 and writes the write information to the storage area of the wireless tag.

Herein, the operation of the read and write device 500 illustrated in the flowchart of FIG. 8 is completed.

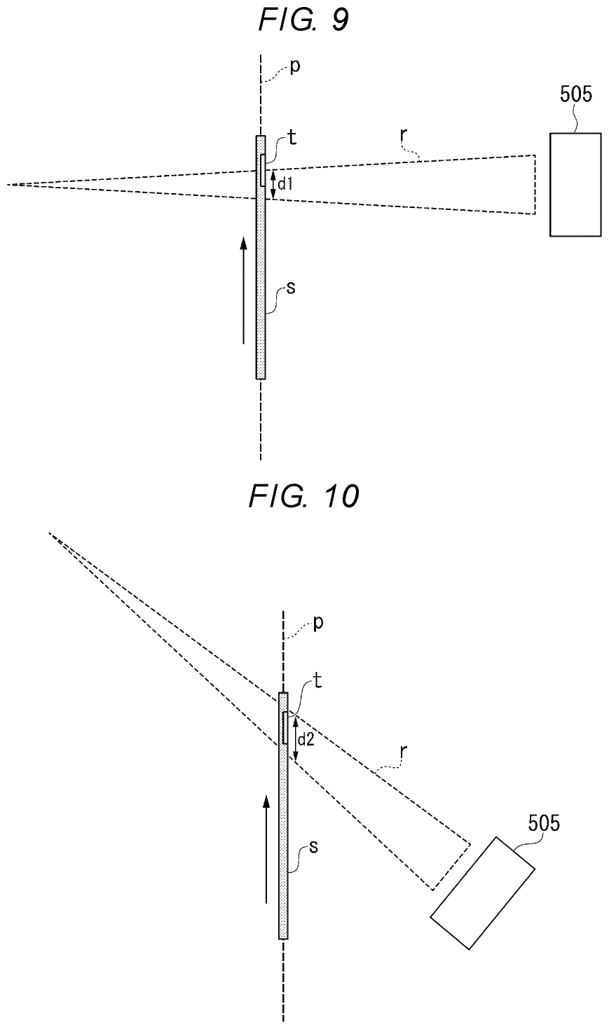

Hereinafter, the relationship between the radiation direction of the electromagnetic wave radiated from the antenna 505 of the read and write device 500 and the direction of the wireless tag is described. FIG. 9 is a schematic diagram illustrating a relationship between a radiation direction of general electromagnetic waves and a direction of the wireless tag.

The electromagnetic wave radiated from the antenna 505 is a directional electromagnetic wave using, for example, a UHF band. If electromagnetic waves in the UHF band are used, the size of the antenna 505 and the size of the wireless tag can be reduced. If electromagnetic waves in the UHF band are used, the communication distance between the read and write device 500 and the wireless tag can be made relatively long (for example, 1 to 3 meters).

When a wireless tag t attached to a sheet s conveyed along a conveyance path p is within the irradiation range r of the electromagnetic waves, the antenna 505 and the wireless tag t can communicate with each other. As illustrated in FIG. 9, the radiation direction of the electromagnetic waves radiated from the antenna 505 is generally orthogonal to the direction of the wireless tag t. In this case, a length of a range in which the antenna 505 and the wireless tag t can communicate with each other on the conveyance path p is a length d1 as illustrated in FIG. 9.

Otherwise, FIG. 10 is a schematic diagram illustrating the relationship between the radiation direction of the electromagnetic waves and the direction of the wireless tag in the exemplary embodiment. In the same manner as in FIG. 9, the electromagnetic waves radiated from the antenna 505 are, for example, directional electromagnetic waves using the UHF band. When the wireless tag t attached to the sheet s conveyed along the conveyance path p is within the irradiation range r of the electromagnetic waves, the antenna 505 and the wireless tag t can communicate with each other. As illustrated in FIG. 10, in the present exemplary embodiment, the radiation direction of the electromagnetic wave radiated from the antenna 505 is oblique to the direction of the wireless tag t. In this case, a length of a range in which the antenna 505 and the wireless tag t can communicate with each other on the conveyance path p is a length d2 as illustrated in FIG. 10.

As can be seen by comparing the length d1 illustrated in FIG. 9 with the length d2 illustrated in FIG. 10, the length d2 is longer than the length d1. That is, in the present exemplary embodiment, the length of the range in which the antenna 505 and the wireless tag t can communicate with each other on the conveyance path p is longer than that in related art. Thereby, the image forming system 1 according to the present exemplary embodiment can improve the accuracy of writing and reading information to and from the wireless tag by the read and write device 500 as compared with the related art.

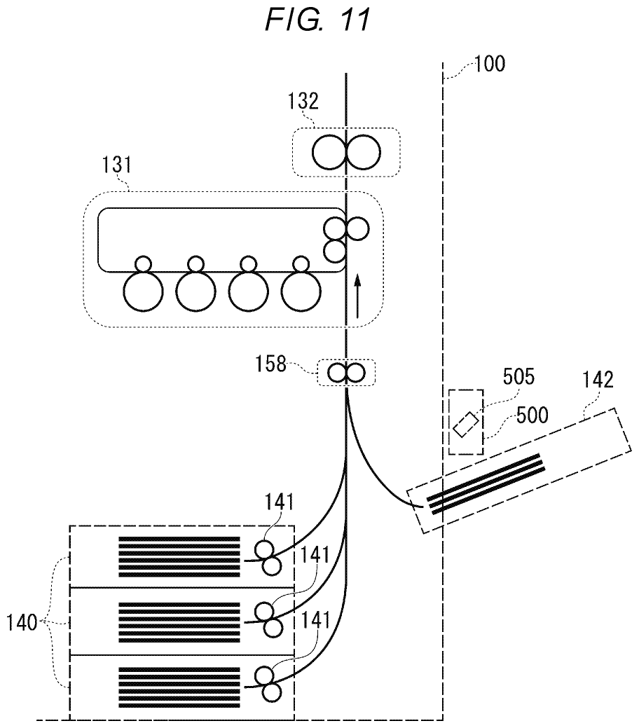

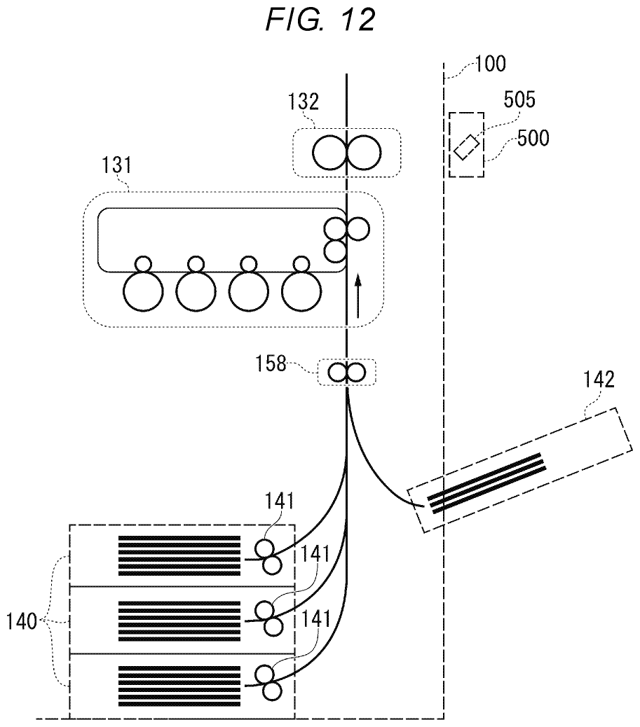

Hereinafter, an example of a position for providing the read and write device 500 with respect to the image forming apparatus 100 is described. FIGS. 11 and 12 are diagrams illustrating positions for providing the read and write device 500 to the image forming apparatus 100.

The image forming apparatus 100 illustrated in FIG. 11 includes three sheet storage units 140 that are automatically fed by the sheet feeding units 141 and a manual feed tray 142. All sheets stored in the sheet storage units 140 and the manual feed tray 142 are conveyed via the registration unit 158 (registration rollers).

As illustrated in FIG. 11, the read and write device 500 is desirably provided, for example, near a position downstream (upper side in the figure) from the position of the registration unit 158 in the conveyance path of the sheet in the image forming apparatus 100. This is because the position downstream of the position of the registration unit 158 in the conveyance path of the sheet is a position through which all sheets pass. Accordingly, the antenna 505 of the read and write device 500 can communicate with all the wireless tags attached respectively to the sheets stored in the sheet storage units 140 and the manual feed tray 142.

Also, as illustrated in FIG. 11, the read and write device 500 is desirably provided at a position near the registration unit 158. This is because, generally, near the registration unit 158 inside the image forming apparatus 100, image forming components are not densely packed, and the space is sufficient in many cases. Further, this is because, generally, near the registration unit 158, metal components are not so much provided in many cases. Therefore, the transmission and reception of the electromagnetic wave between the read and write device 500 and the wireless tag is hardly hindered. Accordingly, the read and write device 500 can perform communication with the wireless tag with higher accuracy.

Generally, at a position near the registration unit 158 in the conveyance path of the sheet, the conveyance speed is temporarily reduced or the conveyance is temporarily stopped in many cases. Therefore, it is less likely that the writing of the write information to the wireless tag by the read and write device 500 fails. Accordingly, the read and write device 500 can communicate with the wireless tag with higher accuracy.

As illustrated in FIG. 12, the read and write device 500 may be provided, for example, near a position downstream (upper side in the figure) the position of the fixing unit 132 in the conveyance path of the sheet in the image forming apparatus 100. This is because, in the fixing unit 132, the sheet passes through a nip portion (not illustrated) with high temperature and pressure. Thereby, data written to the wireless tag is possibly damaged. By reading and writing data from and to the wireless tag at a position downstream of the position of the fixing unit 132, the risk of data corruption is reduced.

As described above, the read and write device 500 may be provided at a position near the registration unit 158 and may be provided near a position upstream of the position of the fixing unit 132 in the conveyance path of the sheet in the image forming apparatus 100.

As described above, in the image forming system 1 according to the present exemplary embodiment, the position for providing the read and write device 500 and the radiation direction of the electromagnetic wave are set so as to increase the accuracy of communication between the read and write device 500 and the wireless tag. The electric field strength of the electromagnetic wave may be set so as to increase the accuracy of communication between the read and write device 500 and the wireless tag. In this case, for example, it is conceivable to suppress the electric field strength so that writing is not performed on a wireless tag different from the wireless tag to which the write information is to be written and set the electric field strength to a higher value thereafter.

In the above exemplary embodiment, the image information and the write information are associated with each other. That is, the write information associated with the image information is written to the wireless tag attached to the sheet on which the image is formed using the image information. However, the invention is not limited to this configuration, and the image information and the write information may not be associated with each other. For example, a configuration in which common write information is written to all wireless tags may be used.

In the above exemplary embodiment, the image forming apparatus is configured to form an image based on the image information on the sheet to which the wireless tag is attached, and to write the write information to the wireless tag. However, the invention is not limited to this configuration. For example, the image forming apparatus may be configured to write the write information to the wireless tag only and not to form an image on a sheet to which a wireless tag is attached.

In the exemplary embodiment described above, the read and write device 500 writes information to the wireless tag. However, the invention is not limited to this. For example, the read and write device 500 may be configured to read information written in the wireless tag in advance. Otherwise, the read and write device 500 may be configured to perform both reading and writing from and to the wireless tag.

The read and write device 500 may be a device that can be easily attached to and detached from the image forming device 100. Thus, for example, when the read and write device 500 fails to write the write information to the wireless tag, the user can manually execute an operation for rewriting the information. Specifically, rewriting can be performed by the user removing the read and write device 500 from the image forming apparatus 100 and personally bringing the read and write device 500 closer to the wireless tag.

According to the exemplary embodiment described above, the image forming system includes the image forming apparatus and the writing device. The image forming apparatus includes the input and output unit and the image forming unit. The input and output unit is, for example, and I/O device that acquires the image information and the write information to be written to the wireless tag. The I/O device outputs the write information to the writing device. The image forming unit forms an image on a sheet to which the wireless tag is attached based on the image information. The writing device includes the acquisition unit and the writing unit. The acquisition unit acquires the write information. The writing unit writes the acquired write information to the wireless tag via the antenna.

Accordingly, in the image forming system according to the above exemplary embodiment, the read and write device is installed outside the image forming apparatus and thus easily writes and reads information to and from the wireless tag regardless of the internal structure of the image forming apparatus.

In the image forming system according to the above exemplary embodiment, the read and write device can be provided regardless of the internal structure of the image forming device and thus can easily write and read information to and from the wireless tag without depending on a model or a manufacturer of the image forming apparatus.

Generally, an antenna of a read and write device and a control unit (controller) for controlling the corresponding antenna are provided on a substrate. When the substrate is incorporated inside the image forming apparatus, a space of about 50 to 100 [mm] in the sheet conveyance direction and about 300 [mm] in the depth direction is required inside the image forming apparatus. The above numerical values are numerical values assuming that the image forming apparatus can form an image, for example, on an A3-size sheet. When the substrate is incorporated inside the image forming apparatus, components for holding and fixing the antenna and the controller, a shield member, a wiring space, and the like are required. Otherwise, in the image forming system according to the above exemplary embodiment, the read and write device is provided outside the image forming apparatus and thus does not require a design for securing the space. Thereby, the cost for designing the image forming apparatus is reduced.

In related art, when the image information and the write information are associated with each other, a mechanism for matching the sheet conveyance timing with the write information write timing to the wireless tag is required. If this mechanism is not provided, for example, a problem may occur in which write information is written to a wireless tag attached to a sheet different from the sheet on which the write information is to be written. On the other hand, in the image forming system according to the above exemplary embodiment, the read and write device is provided outside the image forming apparatus, and also the read and write device constantly detects the electromagnetic waves radiated from the wireless tag. Therefore, it is not required to incorporate a complicated mechanism for matching the timing into the image forming system according to the above exemplary embodiment as described above. Accordingly, it is expected that the design cost for incorporating the above mechanism into the image forming apparatus and the manufacturing cost for the image forming apparatus is reduced.

Although some exemplary embodiments of the invention have been described, these exemplary embodiments have been presented by way of example only and are not intended to limit the scope of the inventions. These exemplary embodiments can be implemented in other various forms, and various omissions, replacements, and changes can be made without departing from the gist of the invention. These embodiments and modifications thereof are included in the scope and gist of the invention, and are also included in the invention described in the claims and equivalents thereof.

A part of the image forming system 1 in the above exemplary embodiment may be realized by a computer. In that case, a program for realizing the control function of the computer may be recorded on a computer-readable recording medium and the function can be realized by causing a computer system to read and execute the program recorded on the recording medium.

The “computer system” herein is a computer system built in the image forming system 1 and includes software such as an operating system (OS) and hardware such as peripheral devices. The “computer-readable recording medium” includes a portable medium such as a flexible disk, a magneto-optical disk, a flash memory, an electrically erasable programmable read only memory (EEPROM), a read only memory (ROM), a random access read/write memory (RAM), and a compact disc-read only memory (CD-ROM), a storage device such as a hard disk built in a computer system, or a storage medium configured by any combination thereof.

Further, a “computer-readable recording medium” is a medium that dynamically stores a program for a short time, such as a communication line for transmitting a program through a communication network such as the Internet or a communication line such as a telephone line. In this case, a medium that stores a program fora certain period of time, such as a volatile memory inside a computer system serving as a server or a client may be included. The program may be a program for realizing a part of the functions described above, or may be a program for realizing the functions described above in combination with a program recorded in the computer system in advance.

A part of the image forming system 1 in the above exemplary embodiment may be realized with an integrated circuit such as large scale integration (LSI). Each functional block of the image forming system 1 may be individually formed into a processor, or a part or the entire part may be integrated into a processor. The method for forming a circuit integration is not limited to LSI, and may be realized with a dedicated circuit or a general-purpose processor. If a technology for forming an integrated circuit that replaces the LSI appears owing to the progress of the semiconductor technology, an integrated circuit using the technology may be used.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image forming system comprising:
an image forming apparatus comprising:
an I/O device configured to acquire image information and write information from a write information server to be written to a wireless tag,
an image forming unit configured to form an image on a sheet to which the wireless tag is attached based on the image information, and
a processor configured to control the I/O device and the image forming unit; and
a writing device comprising:
an antenna,
an acquisition unit configured to acquire write information from the I/O device, and
a writing unit configured to write the write information to the wireless tag responsive to receiving a signal from the antenna.

2. The system according to claim 1,
wherein the image forming apparatus further comprises a fixing unit disposed in a conveyance path of the sheet to which the wireless tag is attached, and
wherein the writing device is provided outside the image forming apparatus and disposed near a position downstream of the fixing unit in the conveyance path.

3. The system according to claim 1,
wherein the antenna is configured to radiate electromagnetic waves detectable by the writing device, and
the writing device is disposed such that a direction of electromagnetic waves radiated from the antenna is oblique to a conveyance direction of the wireless tag.

4. The system according to claim 1,
wherein the writing device is disposed such that an electric field strength of electromagnetic waves radiated from the antenna is sufficient to perform writing only to a specific wireless tag to which the write information is to be written.

5. The system according to claim 1,
wherein the wireless tag is configured to radiate electromagnetic waves, and
the antenna is configured to constantly detect electromagnetic waves radiated from the wireless tag.

6. The system according to claim 1,
wherein the writing device is detachably provided to the image forming apparatus and is configured to write the write information to the wireless tag outside the image forming apparatus.

7. The system according to claim 1,
wherein the image forming apparatus is configured to convey the sheet to which the wireless tag is attached in a conveyance path, and
the writing device is disposed outside the image forming apparatus near a portion of the conveyance path in which a conveyance speed of the sheet is relatively slow.

8. The system according to claim 1,
wherein the image forming apparatus is configured to convey the sheet to which the wireless tag is attached in a conveyance path, and
the writing device is provided outside the image forming apparatus, near the conveyance path in a space formed such that an image forming component is not provided between the wireless tag inside the image forming apparatus and the writing device.

9. The system according to claim 1,
wherein the image forming apparatus is configured to convey the sheet to which the wireless tag is attached in a conveyance path, and
the writing device is provided outside the image forming apparatus, near the conveyance path in a space formed such that a metal component is not provided between the wireless tag inside the image forming apparatus and the writing device.

10. A method for writing a wireless tag performed by an image forming system including an image forming apparatus and a writing device, the method comprising:
acquiring, at an I/O device, image information and write information to be written to a wireless tag;
forming, at the image forming apparatus, an image on a sheet to which the wireless tag is attached based on the image information;
acquiring, at an acquisition unit of the writing device, the write information from the I/O device;
transmitting, at an antenna of the writing device, a write command signal to a write unit of the writing device; and
writing, at the write unit, the write information to the wireless tag responsive to receiving the write command signal.

11. The method according to claim 10,
further comprising conveying the sheet to which the wireless tag is attached in a conveyance path.

12. The method according to claim 11,
wherein the image forming apparatus comprises a fixing unit disposed in the conveyance path; and
the writing device is provided outside the image forming apparatus and disposed near a position downstream of the fixing unit in the conveyance path.

13. The method according to claim 11,
wherein the writing device is disposed outside the image forming apparatus near a portion of the conveyance path in which a conveyance speed of the sheet is relatively slow.

14. The method according to claim 11,
wherein the writing device is provided outside the image forming apparatus, near the conveyance path in a space formed such that an image forming component is not provided between the wireless tag inside the image forming apparatus and the writing device.

15. The method according to claim 11,
wherein the writing device is provided outside the image forming apparatus near the conveyance path in a space formed such that a metal component is not provided between the wireless tag inside the image forming apparatus and the writing device.

16. The method according to claim 10,
wherein writing the write information to the wireless tag comprises radiating electromagnetic waves detectable by the writing device from the antenna, and
the writing device is disposed such that a direction of electromagnetic waves radiated from the antenna is oblique to a conveyance direction of the wireless tag.

17. The method according to claim 14,
wherein the writing device is disposed such that the electromagnetic waves are of an electric field strength sufficient to perform writing of the write information to a corresponding wireless tag only.

18. The method according to claim 10, further comprising:
radiating, from the wireless tag, electromagnetic waves, and
detecting, at the antenna, electromagnetic waves radiated from the wireless tag.

19. The method according to claim 10,
wherein the writing device is detachably provided to the image forming apparatus and the method further comprises writing the write information to the wireless tag outside the image forming apparatus.

20. the method according to claim 11, further comprising receiving, at the image forming apparatus, image data from at least one of an image scanner or an external processor via a network connection.
